(19) United States
(12) Patent Application Publication
(10) Pub. No.: US 2026/0237915 A1
(43) Pub. Date: Aug. 13, 2026

(54) ANTENNA DEVICE, ARRAY ANTENNA, AND ANTENNA CONTROL METHOD

(71) Applicant: AXELSPACE CORPORATION, Tokyo (JP)

(72) Inventors: Atsushi SHIRANE, Tokyo (JP); Kenichi OKADA, Tokyo (JP); Makoto HIGAKI, Tokyo (JP)

(21) Appl. No.: 19/156,758

(22) PCT Filed: Feb. 16, 2024
(86) PCT No.: PCT/JP2024/005583

§ 371 Date: Aug. 14, 2025

(30) Foreign Application Priority Data
Feb. 17, 2023 (JP) 2023-023164

(51) Int. Cl. H01Q 21/06; H01Q 21/24

(52) U.S. Cl. CPC H01Q 21/065; H01Q 21/245

(57) ABSTRACT

There is provided a first circuit 20 to which a first signal is input and which is for adjusting phase and amplitude, and an antenna element 3 which is connected to the first circuit and which is for radiating electromagnetic waves, wherein the first circuit includes a first branch part 23 for branching the first signal, the first branch part comprises a first branch circuit 24 for branching the first signal and outputting a first branch signal, and a second branch circuit 25 for branching the first signal and outputting a second branch signal, the first branch circuit inputs the first branch signal to a first input part provided in the antenna element, and the second branch circuit includes a first delay circuit 25A for branching the first signal, imparting a first phase difference of 90 degrees relative to the first branch signal, and outputting the second branch signal.

### FIELD

The present invention relates to an antenna device for radiating a circularly polarized wave, an array antenna, and an antenna control method.

### BACKGROUND

In satellite communication, when wireless communication using linearly polarized waves is performed, the polarization direction changes due to the rotational motion of the satellite, and the polarization plane is not fixed, which may make it difficult for the signal radio waves to be received. Thus, circularly polarized waves are used in communication between satellites and mobile objects. Circularly polarized waves have the characteristic wherein the direction of the electric field rotates in a plane perpendicular to the direction of propagation of the electromagnetic wave with a period equal to the excitation frequency thereof. Thus, when satellite communication is performed by wireless communication using circularly polarized waves, signals can be received without determining the polarization plane. For next-generation communication such as 5th generation communication (5G), which is high-speed and high-capacity, networks using satellites which transmit and receive circularly polarized waves are being researched.

For example, Non-Patent Document 1 proposes a phased array antenna which transmits and receives circularly polarized waves. This phased array antenna comprises a plurality of antenna elements. The plurality of antenna elements are arranged in a matrix. Each antenna element is configured to transmit and receive circularly polarized waves. Each antenna element is connected to a first port to which a first signal is input and a second port to which a second signal having a phase difference of ±90° or −90° from the first signal is input.

### CITATION LIST

### Non-Patent Document

[NPL 1] Kevin Kai Wei Low, Samet Zihir, Tumay Kanar, and Gabriel M. Rebeiz, “A 27-31-GHz 1024-Element Ka-Band SATCOM Phased-Array Transmitter With 49.5-dBW Peak EIRP, 1-dB AR, and ±70 Beam Scanning”, IEEE TRANSACTIONS ON MICROWAVE THEORY AND TECHNIQUES, VOL. 70, No. 3, March 2022.

### SUMMARY

### Technical Problem

The phased array antenna described in Non-PATENT DOCUMENT 1 is provided with a first circuit for generating a first signal for each antenna element, and a second circuit which is provided separately from the first circuit for generating a second signal. Thus, the phased array antenna described in Non-PATENT DOCUMENT 1 has a problem in that the circuit becomes complicated and the configuration becomes large-scale, resulting in increased power consumption. In mobile communications and satellite communications where resources such as power supply are limited, it is desirable to reduce power consumption to the greatest degree possible.

An object of the present invention is to provide an antenna device, an array antenna, and an antenna control method in which the circuit configuration can be simplified and power consumption can be reduced.

### Solution to Problem

One aspect of the present invention provides an antenna device, comprising a first circuit to which a first signal is input and which is for adjusting phase and amplitude, and an antenna element which is connected to the first circuit and which is for radiating electromagnetic waves, wherein the first circuit comprises a first branch part for branching the first signal, the first branch part comprises a first branch circuit for branching the first signal and outputting a first branch signal, and a second branch circuit for branching the first signal and outputting a second branch signal, the first branch circuit inputs the first branch signal to a first input part provided in the antenna element, the second branch circuit comprises a first delay circuit for branching the first signal, imparting a first phase difference of 90 degrees relative to the first branch signal, and outputting the second branch signal, the first delay circuit inputs the second branch signal to a second input part provided in the antenna element in a direction orthogonal to the first branch signal, and the antenna element radiates a circularly polarized wave in a first rotation direction based on a composite wave of the first branch signal input to the first input part and the second branch signal input to the second input part.

### Advantageous Effects of Invention

According to the present invention, in an array antenna, the circuit configuration can be simplified and power consumption can be reduced.

### BRIEF DESCRIPTION OF DRAWINGS

FIG. 1 is a view showing the configuration of an antenna device according to the present invention.

FIG. 2 is a view showing the configuration of a first circuit for generating a circularly polarized wave of a first rotation direction.

FIG. 3 is a view showing the configuration of a second circuit for generating a circularly polarized wave of a second rotation direction.

FIG. 4 is a view showing the operation of a first branch part.

FIG. 5 is a view showing the operation of a second branch part.

FIG. 6 is a view showing the relationship between control voltage and adjustable phase difference.

FIG. 7 is a view showing the configuration of an antenna part.

FIG. 8 is a view showing the configuration of an array antenna.

FIG. 9 is a block view showing the configuration of the array antenna.

FIG. 10 is a view showing characteristics of the array antenna.

### DESCRIPTION OF EMBODIMENTS

### First Embodiment

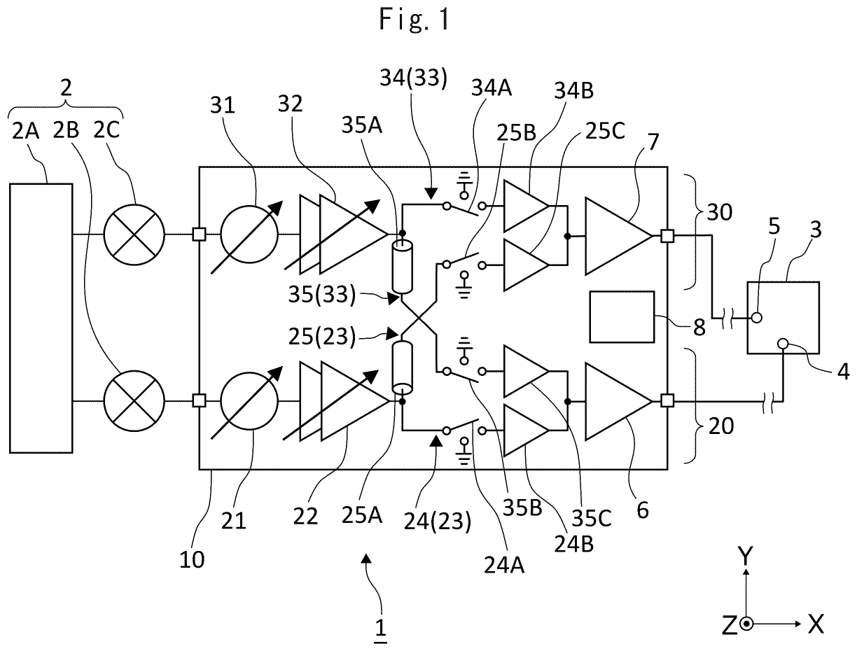

As shown in FIG. 1, an antenna device 1 is configured so as to be capable of radiating a circularly polarized wave. The antenna device 1 is constituted by, for example, a control circuit 10 connected to a signal generation part 2 for generating a signal, and an antenna element 3 connected to the control circuit 10. Though the antenna device 1 is a component of an array antenna, which will be described later, it can also be applied as a standalone device.

The antenna element 3 is, for example, a patch antenna formed in a rectangular shape by a metal thin film. A first input part 4, to which power is input as a signal, is provided on a first side (the bottom side in the drawing) of the antenna element 3. A second input part 5, to which power is input as a signal, is provided on a second side (the left side in the drawing) of the antenna element 3 perpendicular to the first side. A predetermined signal having a predetermined excitation frequency, which excites the antenna element 3, is input to the first input part 4. The antenna element 3 need only generate two electric fields that are geometrically orthogonal to each other using two input parts, and a known antenna element such as a cross dipole antenna or a cross slot antenna can be used.

A predetermined signal, which excites the antenna element 3, is input to the second input part 5 in a direction perpendicular to the first input part 4. The predetermined signal input to the second input part 5 is imparted with a phase difference of ±90 degrees or −90 degrees relative to the signal input to the first input part 4, which will be described later. When the predetermined signal input to the first input part 4 and the predetermined signal input to the second input part 5 are combined, the antenna element 3 generates and radiates an electromagnetic wave which is a circularly polarized wave in the radiation direction.

In the example of FIG. 1, when a phase difference of ±90 degrees is imparted to the predetermined signal input to the second input part 5 relative to the predetermined signal input to the first input part 4, a circularly polarized wave is generated in a right-hand direction (first rotation direction) perpendicular to the sheet of the drawing (facing forward). When a phase difference of −90 degrees is imparted to the predetermined signal input to the second input part 5 relative to the predetermined signal input to the first input part 4, a circularly polarized wave is generated in a left-hand direction (second rotation direction opposite to the first rotation direction) facing forward. The rotation direction of the circularly polarized wave may be changed by changing the positional relationship between the first input part 4 and the second input part 5, or by mutually replacing the signal input to the first input part 4 and the signal input to the second input part 5. The circularly polarized wave radiated from the antenna element 3 has a characteristic that the direction of the electric field rotates in a plane perpendicular to the radiation direction with a period equal to the excitation frequency.

The output side of the control circuit 10 is electrically connected to the first input part 4 and the second input part 5. The input side of the control circuit 10 is electrically connected to the signal generation part 2. The signal generation part 2 is composed of, for example, a baseband part 2A for generating a baseband signal, and a pair of mixers 2B, 2C. The baseband part 2A generates an intermediate frequency (IF) signal (transmission signal) based on the baseband signal in the frequency band of the information to be transmitted.

The IF signal output from the baseband part 2A is input to one of the mixers 2B, 2C, which is selectively selected, and is output as a radio frequency (RF) signal modulated to a radio frequency band frequency based on a local oscillator (LO) (not illustrated) for frequency conversion. The mixer 2B outputs a first signal. The mixer 2C outputs a second signal. The first signal and the second signal may be the same signal or may be different signals. The signal generated by the signal generation part 2 is input to the control circuit 10.

The control circuit 10 adjusts and amplifies the phase and amplitude of the input signals. The control circuit 10 is, for example, a complementary metal-oxide-semiconductor (CMOS) device. The control circuit 10 comprises a first circuit 20 for radiating a right-hand circularly polarized wave from the antenna element 3, and a second circuit 30 for radiating a left-hand circularly polarized wave from the antenna element 3.

The first circuit 20 is a phase-shifting circuit to which the first signal generated by the signal generation part 2 is input and which adjusts and amplifies phase and amplitude. The first circuit 20 functions while a phase adjustment part 31 and an amplifier 32 (which will be described layer) provided in the second circuit 30 are disabled. The signal generation part 2 is connected to the input side of the first circuit 20. The antenna element 3 is connected to the output side of the first circuit 20. The first signal input to the first circuit 20 is first input to a phase adjustment part 21 provided on the input side. The phase adjustment part 21 adjusts the phase of the input first signal. The phase adjustment part 21 may be composed of any circuit as long as it is capable of adjusting the phase of the first signal.

The first signal output from the phase adjustment part 21 is input to an amplifier 22 provided on the output side. The amplifier 22 is a variable gain amplifier (VGA) for adjusting amplitude by amplifying the gain of the input first signal. The amplifier 32 changes the gain of the second signal based on the control voltage. The first signal output from the amplifier 22 is input to a first branch part 23 provided on the output side.

The first branch part 23 is composed of a first branch circuit 24 for branching the first signal into two systems, and a second branch circuit 25. The first signal branched to one system is input to the first branch circuit 24. The first signal branched to the other system is input to the second branch circuit 25.

The first branch circuit 24 is composed of a first switch 24A and an amplifier 24B from the input side. The first switch 24A is configured so as to be capable of switching the first branch circuit 24 between an on state and an off state. The first branch circuit 24 functions when the first switch 24A is in the on state. In the first branch circuit 24, one of the branched first signals is first input to the first switch 24A. In the on state, the first switch 24A inputs one of the first signals to the amplifier 24B.

The amplifier 24B individually finely adjusts the amplitude of one of the input first signals and outputs it. An amplifier 6 is provided on the output side of the amplifier 24B. One of the first signals output from the amplifier 24B is amplified to a predetermined value by the amplifier 6 and output as a first branch signal. The amplifier 6 supplies a fourth branch signal, which is an input high-frequency first branch signal amplified to a required output by an output adjustment part 8, to the antenna element 3. The output adjustment part 8 is configured, for example, by a low drop out (LDO) regulator for outputting a constant voltage based on current detection. The output adjustment part 8 need not necessarily be provided.

The first branch signal output from the amplifier 6 is input to the first input part 4. Specifically, the first branch circuit 24 inputs one of the branched first signals, generates a first branch signal of the same phase as the first signal, and inputs the first branch signal to the first input part 4 provided in the antenna element 3.

The second branch circuit 25 is composed of a first delay circuit 25A, a second switch 25B, and an amplifier 25C from the input side. The second switch 25B is configured so as to be capable of switching the second branch circuit 25 between an on state and an off state. The second branch circuit functions when the second switch 25B is in the on state. In the second branch circuit 25, the other branched first signal is first input to the first delay circuit 25A. The first delay circuit 25A is configured so as to impart the input signal with a delay of ¼ wavelength and output it. Specifically, the first delay circuit 25A imparts a phase difference of 90 degrees to the input signal and outputs it. The first delay circuit 25A may be any circuit as long as it can impart a phase difference to the input signal.

The first delay circuit 25A receives the other first signal and outputs a first delayed signal with a phase difference of 90 degrees. The first delayed signal output from the first delay circuit 25A is input to the second switch 25B, which is in the on state, and the first delayed signal is input to the amplifier 25C. The amplifier 25C individually finely adjusts the amplitude of the first delayed signal and outputs it. An amplifier 7 is provided on the output side of the amplifier 25C. The first delayed signal output from the amplifier 25C is amplified to a predetermined value by the amplifier 7 and output as a second branch signal. The amplifier 7 supplies the second branch signal, which is an input high-frequency first delayed signal amplified to a required output by the output adjustment part 8, to the antenna element 3.

The second branch signal output from the amplifier 7 is input to the second input part 5. Specifically, the second branch circuit 25 receives as input the other branched first signal, imparts a phase difference of 90 degrees as compared to the first branch signal, outputs the second branch signal, and inputs the second branch signal in a direction perpendicular to the first branch signal to the second input part 5 provided in the antenna element 3. Due to the configuration described above, the antenna element 3 radiates a circularly polarized wave in the right-hand direction (first rotation direction) based on the composite wave of the first branch signal input to the first input part 4 and the second branch signal input to the second input part 5.

The second circuit 30 is a phase-shifting circuit to which the second signal generated by the signal generation part 2 is input, and which adjusts the phase and amplitude and amplifies the second signal. The second circuit 30 is configured as a circuit similar to that of the first circuit 20. The second circuit 30 functions while the phase adjustment part 21 and amplifier 22 provided in the first circuit 20 are disabled. In the following description, description of structures which are identical to those of the first circuit 20 have been appropriately omitted.

The signal generation part 2 is connected to the input side of the second circuit 30. The antenna element 3 is connected to the output side of the second circuit 30. The second signal input to the second circuit 30 is first input to the phase adjustment part 31 provided on the input side. The phase adjustment part 31 adjusts the phase of the input second signal.

The second signal output from the phase adjustment part 31 is input to the amplifier 32 provided on the output side. The amplifier 32 is a variable gain amplifier (VGA) for adjusting amplitude by amplifying the gain of the input second signal. The amplifier 32 changes the gain of the second signal based on the control voltage. The third signal output from the amplifier 32 is input to a second branch part 33 provided on the output side.

The second branch part 33 is composed of a third branch circuit 34 for branching the second signal into two systems, and a fourth branch circuit 35. The second signal branched to one system is input to the third branch circuit 34. The second signal branched to the other system is input to the fourth branch circuit 35.

The third branch circuit 34 is composed of a third switch 34A and an amplifier 34B from the input side. The third switch 34A is configured so as to be capable of switching the third branch circuit 34 between an on state and an off state. The third branch circuit 34 functions when the third switch 34A is in the on state. In the third branch circuit 34, one of the branched second signals is first input to the third switch 34A. In the on state, the third switch 34A inputs one of the second signals to the amplifier 34B.

The amplifier 34B individually finely adjusts the amplitude of one of the input second signals and outputs it. The amplifier 7 is provided on the output side of the amplifier 34B. The amplitude of one of the second signals output from the amplifier 34B is amplified to a predetermined value by the amplifier 7 and output as a third branch signal. The amplifier 7 supplies the third branch signal, which is one of the input high-frequency second signals amplified to a required output by the output adjustment part 8, to the antenna element 3.

The third branch signal output from the amplifier 7 is input to the second input part 5. Specifically, the third branch circuit 34 receives as input one of the branched second signals, generates a third branch signal of the same phase as the second signal, and inputs the third branch signal to the second input part 5 provided in the antenna element 3.

The fourth branch circuit 35 is composed of, from the input side, a second delay circuit 35A, a fourth switch 35B, and an amplifier 35C. The fourth switch 35B is configured so as to be capable of switching the fourth branch circuit 35 between an on state and an off state. The fourth branch circuit functions when the fourth switch 35B is in the on state. In the fourth branch circuit 35, the other branched second signal is first input to the second delay circuit 35A. The second delay circuit 35A is configured so as to impart a delay of ¼ wavelength to the input signal and output it. Specifically, the second delay circuit 35A imparts a phase difference of 90 degrees to the input signal and outputs it. Any circuit may be used for the second delay circuit 35A as long as it is capable of imparting a phase difference to the input signal.

The second delay circuit 35A receives the other second signal and outputs a second delayed signal with a phase difference of 90 degrees. The second delayed signal output from the second delay circuit 35A is input to the fourth switch 35B in the on state, which inputs the second delayed signal to the amplifier 35C. The amplifier 35C individually finely adjusts the amplitude of the second delayed signal and outputs it. The amplifier 6 is provided on the output side of the amplifier 35C. The second delayed signal output from the amplifier 35C is amplified to a predetermined value by the amplifier 6 and output as a fourth branch signal. The amplifier 7 supplies the fourth branch signal, which is one of the input high-frequency second delayed signals amplified to the required output level by the output adjustment part 8, to the antenna element 3.

The fourth branch signal output from the amplifier 6 is input to the first input part 4. Specifically, the fourth branch circuit 35 receives as input the other branched second signal, outputs the fourth branch signal by imparting a phase difference of 90 degrees as compared to the third branch signal, and inputs the fourth branch signal to the first input part 4 provided in the antenna element 3 in a direction perpendicular to the third branch signal. The electrical length of the electrical path between the amplifier 6 and the first input part 4 and the electrical length of the electrical path between the amplifier 7 and the second input part 5 are formed so as to be equal. Due to the configuration described above, the antenna element 3 radiates a left-hand (second rotation direction) circularly polarized wave based on a composite wave of the third branch signal input to the second input part 5 and the fourth branch signal input to the first input part 4.

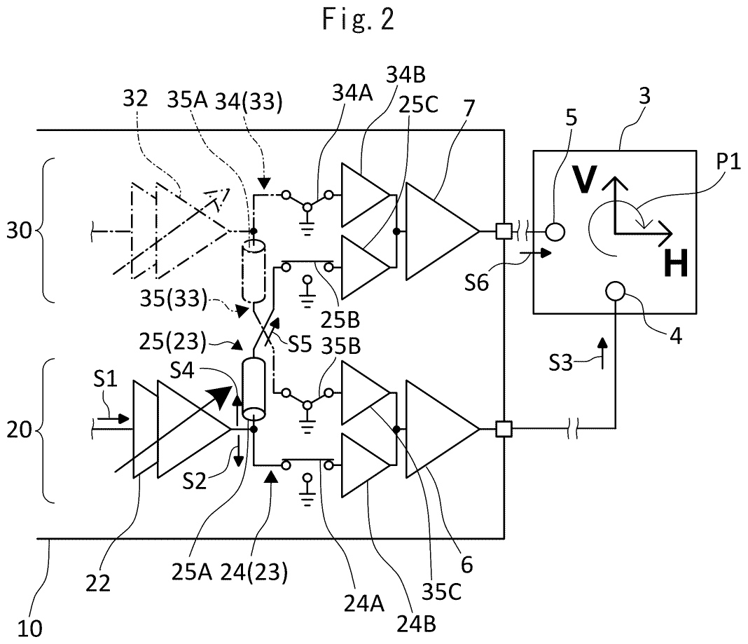

FIG. 2 shows the operation of the first circuit 20. When the first circuit 20 is operating, the second circuit 30 is disabled. At this time, in the second circuit 30, the third switch 34A and the fourth switch 35B of the second branch part 33 are grounded and in the off state. When the first switch 24A and the second switch 25B of the first branch part 23 in the first circuit 20 are in the on state, the first signal S1 input to the first branch part 23 is branched into two by the first branch circuit 24 and the second branch circuit 25.

In the first branch circuit 24, one of the branched first signals S2 is output as a first branch signal S3 via the first switch 24A, the amplifier 24B, and the amplifier 6, and is input to the first input part 4 with the same phase as the first signal S1. In the second branch circuit 25, the other of the branched first signals S4 is input to the first delay circuit 25A. In the first delay circuit 25A, a phase difference of 90 degrees relative to the one first signal S2 is imparted to the other first signal S4, which is output as a first delayed signal S5. The first delayed signal S5 is output as a second branch signal S6 via the second switch 25B, the amplifier 25C, and the amplifier 7, and is input to the second input part 5 with a phase difference of 90 degrees from the first signal S1.

In the antenna element 3, the first branch signal S3 input to the first input part 4 and the second branch signal S6 input to the second input part 5 are combined, and a right-hand (first rotation direction) circularly polarized wave P1 is radiated along the radiation direction. Since the antenna device 1 generates a circularly polarized wave in the first rotation direction based on the first circuit 20, power consumption can be reduced as compared to the prior art for generating a circularly polarized wave in a first rotation direction based on a first circuit and a second circuit.

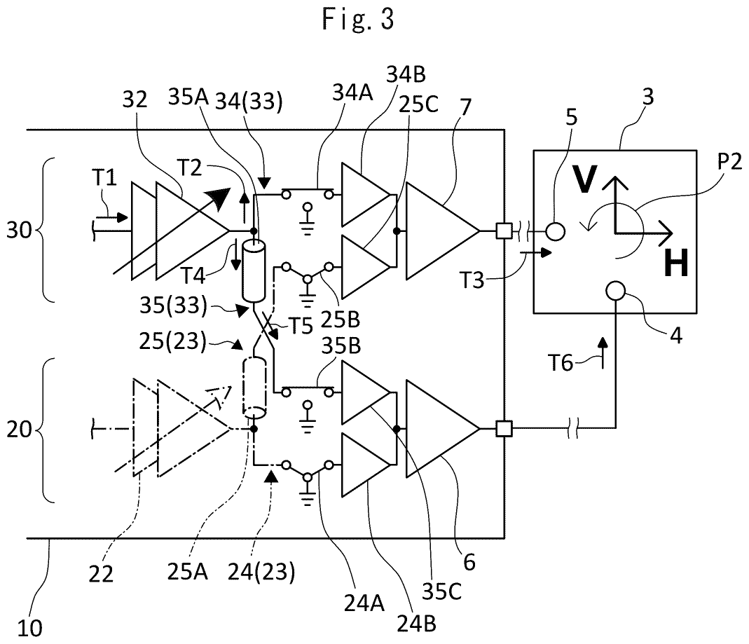

FIG. 3 shows the operation of the second circuit 30. When the second circuit 30 is operating, the first circuit 20 is disabled. At this time, in the first circuit 20, the first switch 24A and the second switch 25B of the second branch part 33 are grounded and in the off state. In the second circuit 30, when the third switch 34A and the fourth switch 35B of the second branch part 33 are in the on state, the second signal T1 input to the second branch part 33 is branched into two by the third branch circuit 34 and the fourth branch circuit 35.

In the third branch circuit 34, one of the branched second signals T2 is output as a third branch signal T3 via the third switch 34A, the amplifier 34B, and the amplifier 7, and is input to the second input part 5 with the same phase as the second signal T1. In the fourth branch circuit 35, the other branched second signal T4 is input to the second delay circuit 35A. In the second delay circuit 35A, a phase difference of 90 degrees relative to the one second signal T2 is imparted to the other branched second signal T4, which is output as a second delayed signal T5. The second delayed signal T5 is output as a fourth branch signal T6 via the fourth switch 35B, the amplifier 35C, and the amplifier 7, and is input to the first input part 4 with a phase difference of 90 degrees from the second signal T1.

In the antenna element 3, the third branch signal T3 input to the second input part 5 and the fourth branch signal T6 input to the first input part 4 are combined, and a left-hand (second rotation direction) circularly polarized wave P2 is radiated along the radiation direction. Since the antenna device 1 generates a circularly polarized wave in the second rotation direction based on the second circuit 30, power consumption can be reduced as compared to the prior art for generating a circularly polarized wave in a second rotation direction based on a first circuit and a second circuit.

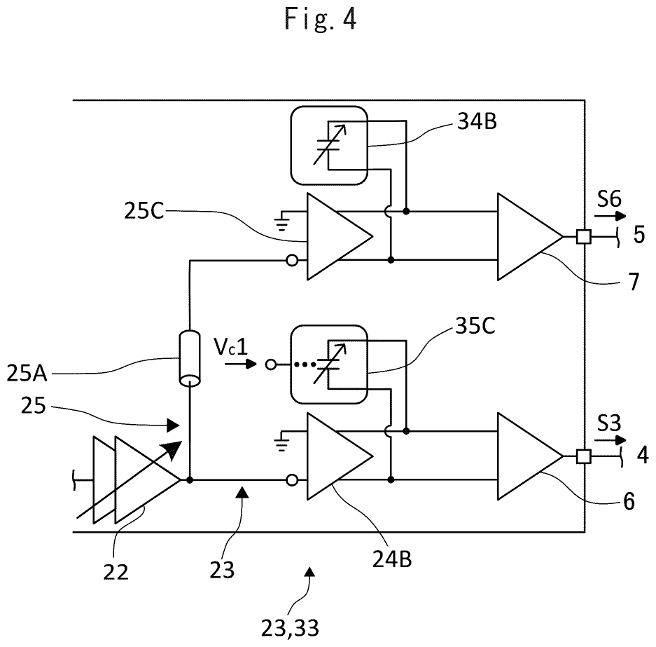

FIG. 4 shows the first branch part 23 of the first circuit 20 in an operating state. When the first branch part 23 of the first circuit 20 is operating, the second branch part 33 of the second circuit 30 connected to the first branch part 23 is in an off state. At this time, the amplifier 35C of the fourth branch circuit 35 of the second branch part 33 functions as a variable capacitance capacitor connected to the first branch part 23.

Thus, the phase of the second branch signal S6 output from the amplifier 7 is adjusted by inputting a first control voltage Vc1 to the amplifier 35C of the second branch part 33. As a result, the phase difference between the second branch signal S6 output from the amplifier 7 and the first branch signal S3 output from the amplifier 6 can be maintained precisely at 90 degrees based on the first control voltage Vc1.

Due to the configuration described above, the first circuit 20 can adjust the phase of the first branch signal S3 based on the first control voltage Vc1 input to the fourth branch circuit 35 connected to the first branch circuit 24. The first circuit 20 may adjust the phase of the second branch signal S6 by inputting the first control voltage Vc1 to the fourth branch circuit 35 connected to the second branch circuit 25.

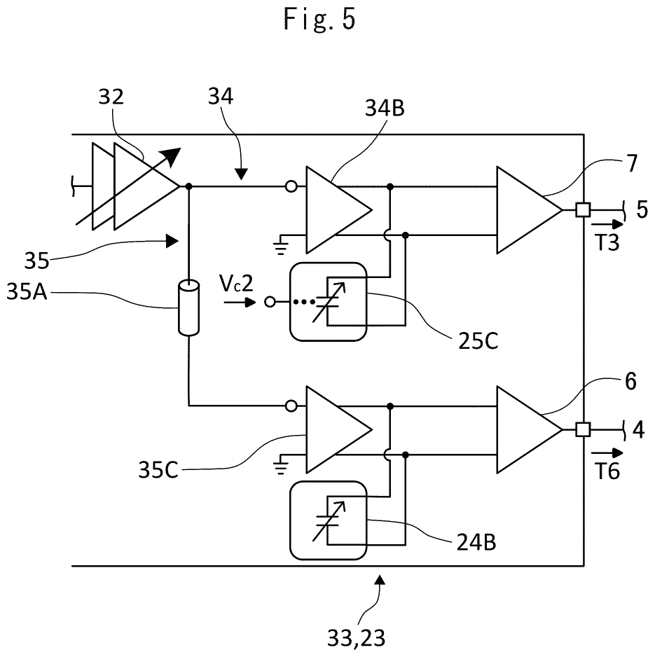

In FIG. 5, when the second branch part 33 of the second circuit 30 is operating, the first branch part 23 of the first circuit 20 connected to the second branch part 33 is in an off state. At this time, the amplifier 25C of the first branch part 23 functions as a variable capacitance capacitor connected to the second branch part 33. Thus, the phase of the third branch signal T3 output from the amplifier 6 is adjusted by inputting a second control voltage Vc2 to the amplifier 25C of the first branch part 23. As a result, the phase difference between the third branch signal T3 output from the amplifier 6 and the fourth branch signal T6 output from the amplifier 7 can be maintained at precisely 90 degrees based on the second control voltage Vc2.

Due to the configuration described above, the second circuit 30 can adjust the phase of the third branch signal T3 based on the second control voltage Vc2 input to the second branch circuit 25 connected to the third branch circuit 34. The second circuit 30 may adjust the phase of the fourth branch signal T6 by inputting the second control voltage Vc2 to the second branch circuit 25 connected to the fourth branch circuit 35.

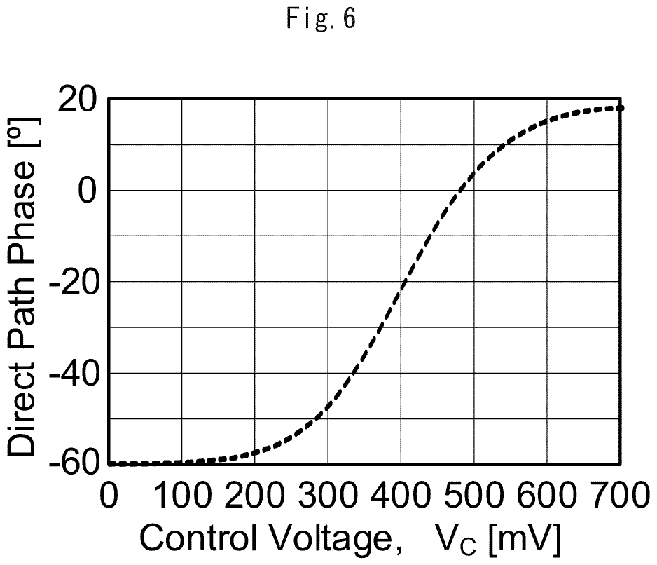

As shown in FIG. 6, the phases of the first branch signal S3 and the third branch signal T3 can be adjusted within a range of 80 degrees from −60 degrees to 20 degrees based on the first control voltage Vc1 and the second control voltage Vc2 (control voltage Vc).

According to the antenna device 1 as described above, since the first branch signal S3 and the second branch signal S6 are generated based on the first circuit 20, and a circularly polarized wave in the first rotation direction is generated, power consumption can be reduced. According to the antenna device 1, since the third branch signal T3 and the fourth branch signal T6 are generated based on the second circuit 30, and a circularly polarized wave is generated in the second rotation direction, power consumption can be reduced.

According to the antenna device 1, while the first circuit 20 is operating, by inputting the first control voltage Vc1 to the amplifier 35C of the second branch part 33 provided in the second circuit 30, which is disabled, the phase difference between the second branch signal S6 output from the amplifier 7 and the first branch signal S3 output from the amplifier 6 can be maintained at precisely 90 degrees.

According to the antenna device 1, while the second circuit 30 is operating, by inputting the second control voltage Vc2 to the amplifier 25C of the first branch part 23 provided in the disabled first circuit 20, it is possible to maintain the phase difference between the third branch signal T3 output from the amplifier 6 and the second branch signal S6 output from the amplifier 7 at precisely 90 degrees.

### Second Embodiment

By using the antenna device 1 of the first embodiment, an array antenna comprising a plurality of antenna elements 3 can be constructed. In the following description, structures which are identical to those of the first embodiment have been assigned the same names and reference signs, and duplicate description thereof has been appropriately omitted.

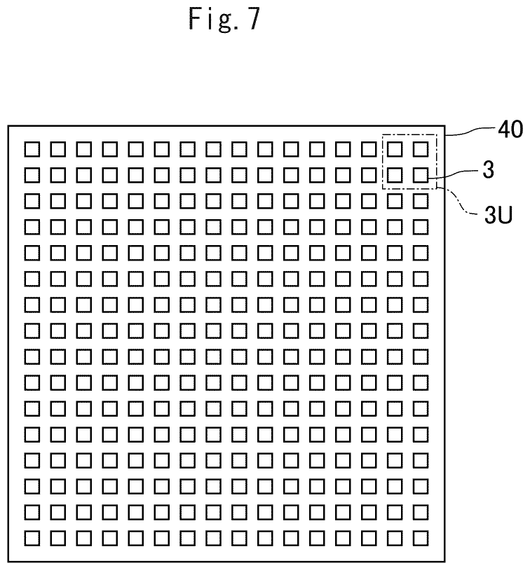

As shown in FIG. 7, the array antenna 100 comprises an antenna part 40 in which a plurality of antenna elements 3 are arranged in an m×n (m and n are arbitrary natural numbers) matrix. For example, 16×16=256 antenna elements 3 are arranged in the antenna part 40. The array antenna 100 is formed into a phased array antenna in which the plurality of antenna elements 3 are arranged. In the antenna part 40, the number and arrangement of the antenna elements 3 may be changed.

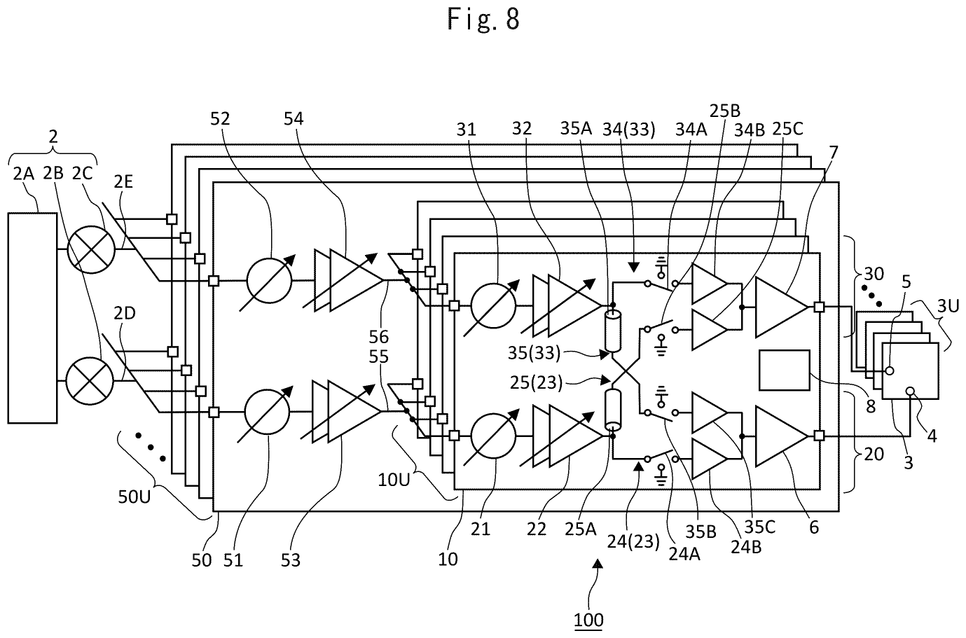

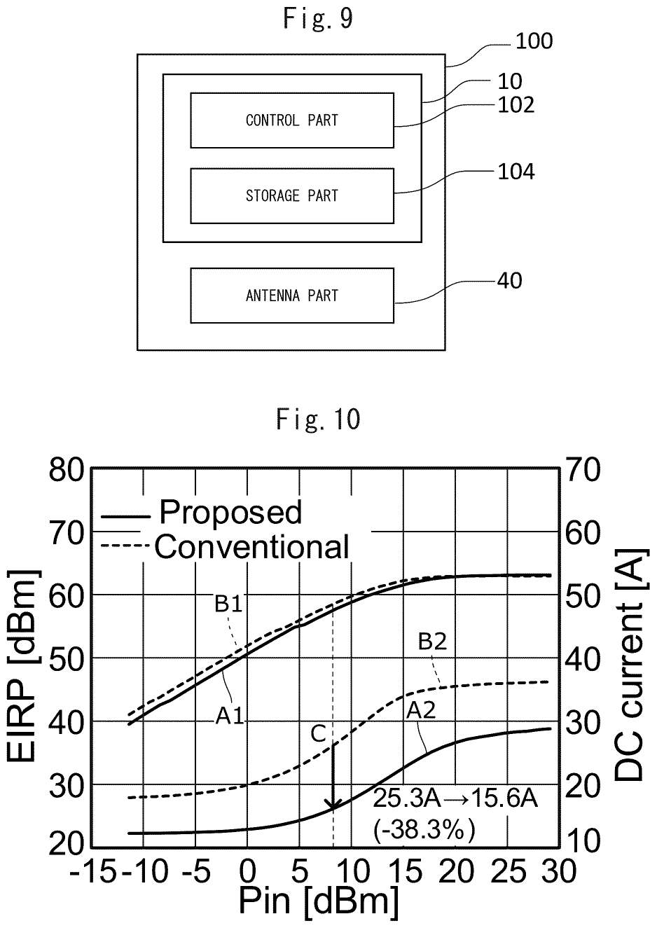

As shown in FIGS. 8 and 9, the array antenna 100 comprises a controller 50U including a plurality of antenna devices 1, a signal generation part 2 for generating a first signal and a second signal to be input to the controller 50U, a control part 102 for controlling the controller 50U, an antenna part 40 in which the plurality of antenna elements 3 are arranged, and a storage part 104 for storing data and programs used in control. The controller 50U is configured so as to adjust a phase shift amount including the phase and amplitude of the input first signal and second signal.

The controller 50U is constituted by 64 radiation circuits 50. In the controller 50U, the number of radiation units 10U is not limited to 64. Each radiation circuit 50 includes a radiation unit 10U. The radiation unit 10U is composed of four control circuits 10. The four control circuits 10 control the circularly polarized waves radiated from four antenna elements out of the plurality of antenna elements 3 arranged in the antenna part 40. In the radiation unit 10U, the number of control circuits 10 is not limited to four.

For example, the signal generation part 2 is connected to the input side of 64 radiation circuits 50 in the controller 50U. The signal generation part 2 is controlled by the control part 102. The signal generation part 2 and each radiation circuit 50 are connected by a first electrical path 2D and a second electrical path 2E. The first electrical path 2D and the second electrical path 2E are connected by, for example, a tournament connection, such that the electrical lengths between the signal generation part 2 and each radiation circuit 50 are equal (refer to Non-Patent Document 1). A first signal is input to the first electrical path 2D. A second signal is input to the second electrical path 2E.

The first electrical path 2D and the second electrical path 2E are connected to the input side of each radiation circuit 50.

The radiation circuit 50 adjusts the phase shift amount including the phase and amplitude of the input first signal and second signal according to the beam direction of the circularly polarized wave radiated from the radiation unit 10U. A pair of phase adjustment parts 51, 52 and a pair of amplifiers 53, 54 are provided on the input side of the radiation circuit 50. The phase adjustment parts 51, 52 adjust the phases of the input signals. The amplifiers 53, 54 are composed of variable gain amplifiers capable of adjusting the amplitudes of the input signals.

The first electrical path 2D is connected to the input side of the phase adjustment part 51. The output side of the phase adjustment part 51 is connected to the input side of the amplifier 53. The output side of the amplifier 53 is connected to the input side of the radiation unit 10U. The output side of the amplifier 53 and the input side of each control circuit 10 of the radiation unit 10U are connected by a third electrical path 55. The third electrical path 55 is connected by, for example, a tournament connection such that the electrical lengths between the amplifier 53 and each control circuit 10 are equal (refer to Non-Patent Document 1). The third electrical path 55 is connected to the input side of the phase adjustment part 21 of each control circuit 10.

The second electrical path 2E is connected to the input side of the phase adjustment part 52. The output side of the phase adjustment part 52 is connected to the input side of the amplifier 54. The output side of the amplifier 54 is connected to the input side of the radiation unit 10U. The output side of the amplifier 54 and the input side of each control circuit 10 of the radiation unit 10U are connected by a fourth electrical path 56. The fourth electrical path 56 is connected by, for example, a tournament connection such that the electrical lengths between the amplifier 54 and each control circuit 10 are equal (refer to Non-Patent Document 1). The fourth electrical path 56 is connected to the input side of the phase adjustment part 31 of each control circuit 10.

Due to the configuration described above, the signal generation part 2 distributes and inputs the generated first signal to each radiation circuit 50 via the first electrical path 2D. In each radiation circuit 50, the first signal is first input to the phase adjustment part 51. The phase adjustment part 51 adjusts the phase of the input first signal according to the beam direction of the circularly polarized wave radiated from the radiation unit 10U. The first signal having the adjusted phase amount is input to the amplifier 53. The amplifier 53 adjusts the amplitude of the first signal. The first signal having the phase shift amount adjusted by the phase adjustment part 51 and the amplifier 53 is input to the radiation unit 10U. The radiation unit 10U inputs the first signal having the adjusted phase shift amount, and radiates the right-hand circularly polarized wave from the plurality of antenna elements 3.

Likewise, the signal generation part 2 distributes and inputs the generated second signal to each radiation circuit 50 via the second electrical path 2E. In each radiation circuit 50, the second signal is first input to the phase adjustment part 52. The phase adjustment part 52 adjusts the phase of the input second signal in accordance with the beam direction of the circularly polarized wave radiated from the radiation unit 10U. The second signal having the adjusted phase amount is input to the amplifier 54. The amplifier 54 adjusts the amplitude of the second signal. The second signal having the phase shift amount adjusted by the phase adjustment part 52 and the amplifier 54 is input to the radiation unit 10U. The radiation unit 10U inputs the second signal having the adjusted phase shift amount, and radiates the left-hand circularly polarized wave from the plurality of antenna elements 3.

As shown in FIG. 9, the control part 102 executes processing related to an antenna control method based on data and programs stored in, for example, the storage part 104 to control the array antenna 100. The control part 102 individually controls the phase amount of the first signal input to the plurality of antenna devices 1 for each antenna device 1, and adjusts the beam direction of the right-hand (first rotation direction) circularly polarized wave radiated from the antenna part 40. The control part 102 controls each antenna device 1 to generate a first branch signal branched from the first signal and a second branch signal to which a first phase difference of 90 degrees relative to the first branch signal has been imparted, and generates a right-hand circularly polarized wave radiated from the antenna part 40. The control part 102 adjusts the phase of the first branch signal based on the first control voltage, and compensates for the first phase difference between the first branch signal and the second branch signal.

The control part 102 individually controls the phase amount of the second signal input to the plurality of antenna devices for each antenna device 1, and adjusts the beam direction of the left-hand (second rotation direction) circularly polarized wave radiated from the antenna part 40. The control part 102 controls each antenna device 1 to generate a third branch signal branched from the second signal, and a fourth branch signal imparted with a second phase difference of 90 degrees relative to the third branch signal, and generates the left-hand circularly polarized wave radiated from the antenna part 40. The control part 102 adjusts the phase of the third branch signal based on the second control voltage, and compensates for the second phase difference between the third branch signal and the fourth branch signal.

The control part 102 is configured such that a hardware processor such as a central processing unit (CPU) executes a program stored in the storage part 104. A part or all of the control part 102 may be realized by hardware (including circuitry) such as large-scale integration (LSI), an application-specific integrated circuit (ASIC), a field-programmable gate array (FPGA), or a graphics processing unit (GPU), or may be realized by cooperation between software and hardware. The program may be stored in a storage device such as a hard disk drive (HDD) or flash memory included in the storage part 104 in advance, or may be stored in a removable storage medium such as a DVD or CD-ROM, and may be installed by mounting the storage medium in a drive device. Furthermore, the program is not necessarily indispensable, and predetermined operations may be executed by constructing sequence circuits in the control circuit 10.

FIG. 10 shows a comparison result between the power consumption of the array antenna 100 and the power consumption of the prior art (refer to, for example, Non-Patent Document 1). Curve Al represents the transmission power equivalent isotropic radiated power (EIRP) of the electromagnetic wave radiated from the array antenna 100. Curve B1 represents the transmission power EIRP of the electromagnetic wave radiated from the array antenna of the prior art. Curve A2 represents the power supply current input to the array antenna 100. Curve B2 represents the power supply current input to the array antenna of the prior art. As shown in the drawing, for example, the power supply current required for the array antenna 100 to obtain the same transmission power as the prior art at point C is 15.6 A. Since the power supply current required in the prior art is 25.3 A, the power supply current is reduced by 38.3% in the array antenna 100.

Each embodiment according to the present invention is an example and does not limit the scope of the invention. These embodiments can be implemented in various other forms. These embodiments can be variously omitted, replaced, and modified without departing from the spirit of the invention. These embodiments and modifications thereof are included in the scope of the invention described in the claims and equivalents thereof, as well as in the scope and spirit of the invention.

For example, in the array antenna 100, the control part 102 may adjust the phase and amplitude of the first branch signal in the first circuit 20, adjust the phase shift amount between the first branch signal and the second branch signal, and adjust the beam direction radiated from the antenna part 40. In the array antenna 100, the control part 102 may adjust the phase and amplitude of the third branch signal in the second circuit 30, adjust the phase shift amount between the third branch signal and the fourth branch signal, and adjust the beam direction radiated from the antenna part 40.

In the array antenna 100, the control part 102 may adjust the phase and amplitude of the first branch signal in the first circuit 20, and adjust the phase shift amount between the first branch signal and the second branch signal in accordance with the beam direction radiated from the antenna part 40, to compensate for the transmission signal. In the array antenna 100, the control part 102 may adjust the phase and amplitude of the third branch signal in the second circuit 30, and adjust the phase shift amount between the third branch signal and the fourth branch signal in accordance with the beam direction radiated from the antenna part 40, to compensate for the transmission signal.

### DESCRIPTION OF REFERENCE SIGNS

1 antenna device
2 signal generation part
2A baseband part
2B mixer
2C mixer
2D first electrical path
2E second electrical path
3 antenna element
4 first input part
5 second input part
6 amplifier
7 amplifier
8 output adjustment part
10 control circuit
10U radiation unit
20 first circuit
21 phase adjustment part
22 amplifier
23 first branch part
24 first branch circuit
24A first switch
24B amplifier
25 second branch circuit
25A first delay circuit
25B second switch
25C amplifier
30 second circuit
31 phase adjustment part
32 amplifier
33 second branch part
34 third branch circuit
34A third switch
34B amplifier
35 fourth branch circuit
35A second delay circuit
35B fourth switch
35C amplifier
40 antenna part
50 radiation circuit
50U controller
51 phase adjustment part
52 phase adjustment part
53 amplifier
54 amplifier
55 third electrical path
56 fourth electrical path
100 array antenna
102 control part
104 storage part

1. An antenna device, comprising:
a first circuit to which a first signal is input and which is for adjusting phase and amplitude, and
an antenna element which is connected to the first circuit and which is for radiating electromagnetic waves, wherein
the first circuit comprises a first branch part for branching the first signal,
the first branch part comprises a first branch circuit for branching the first signal and outputting a first branch signal, and a second branch circuit for branching the first signal and outputting a second branch signal,
the first branch circuit inputs the first branch signal to a first input part provided in the antenna element,
the second branch circuit comprises a first delay circuit for branching the first signal, imparting a first phase difference of 90 degrees relative to the first branch signal, and outputting the second branch signal,
the first delay circuit inputs the second branch signal to a second input part provided in the antenna element in a direction orthogonal to the first branch signal, and
the antenna element radiates a circularly polarized wave in a first rotation direction based on a composite wave of the first branch signal input to the first input part and the second branch signal input to the second input part.

2. The antenna device according to claim 1, further comprising a second circuit which is connected to the antenna element, to which a second signal is input, and which is for adjusting phase and amplitude, wherein
the second circuit comprises a second branch part for branching the second signal,
the second branch part comprises a third branch circuit for branching the second signal and outputting a third branch signal, and a fourth branch circuit for branching the second signal and outputting a fourth branch signal,
the third branch circuit inputs the third branch signal to the second input part,
the fourth branch circuit comprises a second delay circuit for branching the second signal, imparting a second phase difference of 90 degrees relative to the third branch signal, and outputting the fourth branch signal,
the second delay circuit inputs the fourth branch signal to the first input part in a direction orthogonal to the third branch signal, and
the antenna element radiates a circularly polarized wave in a second rotation direction opposite to the first rotation direction based on a composite wave of the third branch signal input to the second input part and the fourth branch signal input to the first input part.

3. The antenna device according to claim 2, wherein the first circuit adjusts a phase of the first branch signal based on a first control voltage input to the fourth branch circuit connected to the first branch circuit.

4. The antenna device according to claim 2, wherein the second circuit adjusts a phase of the third branch signal based on a second control voltage input to the second branch circuit connected to the third branch circuit.

5. An array antenna, comprising:
a controller having a plurality of the antenna devices according to claim 1,
a signal generation part for generating the first signal to be input to the controller,
a control part for controlling the controller, and
an antenna part in which a plurality of the antenna elements are arranged, wherein
the control part controls a phase amount of the first signal to be input to the plurality of antenna devices individually for each of the antenna devices, and adjusts a beam direction of the circularly polarized wave in the first rotation direction radiated from the antenna part.

6. The array antenna according to claim 5, wherein the signal generation part generates a second signal to be input to the controller, and
the control part controls a phase amount of the second signal to be input to the plurality of antenna devices individually for each of the antenna devices, and adjusts a beam direction of the circularly polarized wave in a second rotation direction opposite to the first rotation direction radiated from the antenna part.

7. An antenna control method for an antenna device comprising a first circuit for adjusting phase and amplitude and an antenna element which is connected to the first circuit and which is for radiating electromagnetic waves, the method comprising the steps of:
inputting a first signal to the first circuit,
inputting one of the first signals branched from the first signal to a first branch circuit provided in the first circuit and outputting a first branch signal,
inputting the first branch signal to a first input part provided in the antenna element from the first branch circuit,
inputting another of the branched first signals to a second branch circuit provided in the first circuit, imparting, in a first delay circuit provided in the second branch circuit, a first phase difference of 90 degrees relative to the first branch signal to the other first signal, and outputting a second branch signal,
inputting the second branch signal to a second input part provided in the antenna element in a direction perpendicular to the first branch signal, and
radiating, in the antenna element, a circularly polarized wave in a first rotation direction based on a composite wave of the first branch signal input to the first input part and the second branch signal input to the second input part.

8. The antenna control method according to claim 7, further comprising the steps of:
inputting a second signal to a second circuit which is connected to the antenna element and which is for adjusting phase and amplitude,
inputting one of the second signals branched from the second signal to a third branch circuit provided in the second circuit and outputting a third branch signal,
inputting the third branch signal to the second input part from the third branch circuit,
inputting the other of the second signals branched from the second signal to a fourth branch circuit provided in the second circuit, imparting, in a second delay circuit provided in the fourth branch circuit, a second phase difference of 90 degrees relative to the third branch signal to the other second signal, and outputting a fourth branch signal,
inputting the fourth branch signal to the first input part in a direction perpendicular to the third branch signal, and
radiating, in the antenna element, a circularly polarized wave in a second rotation direction opposite to the first rotation direction based on a composite wave of the third branch signal input to the second input part and the fourth branch signal input to the first input part.
